(19) United States
(12) Patent Application Publication
(10) Pub. No.: US 2026/0339859 A1
(43) Pub. Date: Oct. 29, 2026

(54) INFORMATION PROCESSING APPARATUS, METHOD, AND STORAGE MEDIUM

(71) Applicant: Toshiba Tec Kabushiki Kaisha, Tokyo (JP)

(72) Inventor: Yasuhiro KATABIRA, Tagata Shizuoka (JP)

(21) Appl. No.: 19/643,649

(22) Filed: Apr. 9, 2026

(30) Foreign Application Priority Data
Apr. 23, 2025 (JP) 2025-071721

(51) Int. Cl. G06F 13/20; G06F 3/14; G06F 9/4401

(52) U.S. Cl. CPC G06F 13/20; G06F 3/14; G06F 9/4401; G06F 2213/40

(57) ABSTRACT

An information processing apparatus includes a mainboard including a first processor configured to control operation of the information processing apparatus; an input/output (I/O) board connected to the mainboard and configured to control peripheral devices connected to the information processing apparatus; and a display board connected to the mainboard and including a display device. At least two of the mainboard, the I/O board, and the display board include respective boot devices, each of the boot devices storing software to be executed during boot of the information processing apparatus; one of the I/O board and the display board includes a switch configurable to specify one of the boot devices; and the mainboard is configured to determine the one of the boot devices specified by the switch and execute the software stored in the determined one of the boot devices to boot the information processing apparatus.

### CROSS-REFERENCE TO RELATED APPLICATION

This application is based upon and claims the benefit of priority from Japanese Patent Application No. 2025-071721, filed Apr. 23, 2025, the entire contents of which are incorporated herein by reference.

### FIELD

Embodiments described herein relate generally to an information processing apparatus, a method, and a storage medium.

### BACKGROUND

Information processing apparatuses (or sales data processing apparatuses), such as point-of-sale (POS) terminals, are used in stores, such as supermarkets. Also, there is an information processing apparatus including multiple storage devices that store operating systems (OS) and applications for controlling the information processing apparatus. For example, a known computer device is configured to select a storage device to use during boot according to the state of a hardware switch.

Here, with the increase in the performance of information processing apparatuses, it is desired to modularize and reduce the size of a board with a processor for controlling the information processing apparatuses. However, when a board with the hardware switch described above is placed inside the housing of an information processing apparatus in line with this trend, the operability of the hardware switch may be reduced.

An aspect of the present disclosure provides an information processing apparatus, a method, and a storage medium that enable easy selection of a boot device.

### SUMMARY

Embodiments of the present disclosure provide an information processing apparatus that includes a mainboard including a first processor configured to control operation of the information processing apparatus; an input/output (I/O) board connected to the mainboard and including a second processor configured to control peripheral devices connected to the information processing apparatus; and a display board connected to the mainboard and including a display device and a third processor configured to control the display device. At least two of the mainboard, the I/O board, and the display board include respective boot devices, each of the boot devices storing software to be executed during boot of the information processing apparatus; one of the I/O board and the display board includes a switch configurable to specify one of the boot devices; and the first processor of the mainboard is configured to determine the one of the boot devices specified by the switch and execute the software stored in the determined one of the boot devices to boot the information processing apparatus.

### BRIEF DESCRIPTION OF THE DRAWINGS

FIG. 1 is a perspective view of a POS terminal according to an embodiment.

FIG. 2 is a block diagram illustrating a hardware configuration of the POS terminal.

FIG. 3 is a block diagram illustrating a hardware configuration of a mainboard.

FIG. 4 shows an example of the data structure of a boot device setting table.

FIG. 5 is a block diagram illustrating a hardware configuration of a display board.

FIG. 6 is a block diagram illustrating a hardware configuration of an I/O board.

FIG. 7 is a block diagram illustrating a functional configuration of a control unit implemented by a BIOS.

FIG. 8 is a flowchart illustrating a process performed by the POS terminal.

### DETAILED DESCRIPTION

Hereinafter, embodiments will be described in detail with reference to the drawings. The present disclosure is not limited to the embodiments described below.

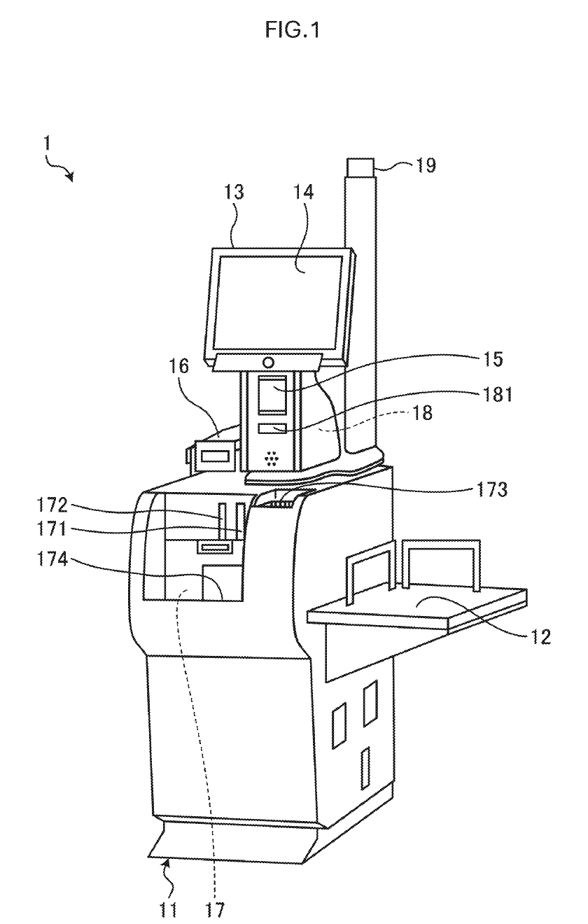

First, a POS terminal 1 according to an embodiment is described. FIG. 1 is a perspective view of the POS terminal 1 according to the embodiment.

The POS terminal 1 is an example of an information processing apparatus. The POS terminal 1 performs a registration process for registering items to be purchased and a payment process for the registered items. Here, "items" include products (or tangible items) to be purchased and services (or intangible items), such as a bill payment service.

Here, the registration process refers to a process for obtaining item information based on an item code, displaying the item information, and storing the item information. The item information includes, for example, the name of an item, the price (or unit price) of the item, and a tax category indicating whether the item is tax-inclusive or tax-exclusive that are associated with the item code. Also, the payment process refers to a process for receiving a payment method, processing a payment according to the payment method, and issuing a receipt.

The POS terminal 1 is, for example, a regular register used by a store clerk to register items and process a payment for the items, a semi-self-service register that is used by a store clerk to register items and is used by a customer to pay for the items, a full-self-service register used by a customer to register items and pay for the items, or one of a registration device and a payment device constituting a distributed semi-self-service system.

The POS terminal 1 includes a main unit 11 and a first platform 12 that is disposed on one side of the main unit 11 and on which items are placed before registration. The main unit 11 includes input/output devices (or peripheral devices) used to input information to or output information from the POS terminal 1.

Specifically, the main unit 11 includes a display device 13, an operation device 14, a scanner 15, a card reader/writer 16, a change machine 17, a receipt printer 18, and a warning light 19.

The display device 13 is, for example, a liquid crystal panel or an organic electroluminescent (EL) panel and displays various screens according to commands from a control unit 300 (see FIG. 5).

The operation device 14 is, for example, a touch panel that is stacked on the display surface of the display device 13. The operation device 14 outputs information indicating positions touched by the customer to the control unit 300.

The scanner 15 is a so-called fixed scanner and includes an imaging window and an imaging unit (not shown) disposed behind the imaging window. The imaging unit captures a code symbol, such as a bar code, that is attached to an item to be purchased and is held by the customer over the imaging window to register the item. An item code, which is identification information for uniquely identifying the item, is registered in the code symbol. The imaging unit decodes information registered in the code symbol to obtain the item code. The POS terminal 1 obtains item information of an item held over the scanner 15 by comparing the item code with an item master and registers the item.

The POS terminal 1 may also include a handheld scanner (not shown) in addition to the scanner 15. The handheld scanner may be used to read a code symbol attached to an item when the item is heavy or large and it is difficult to hold the code symbol over the scanner 15.

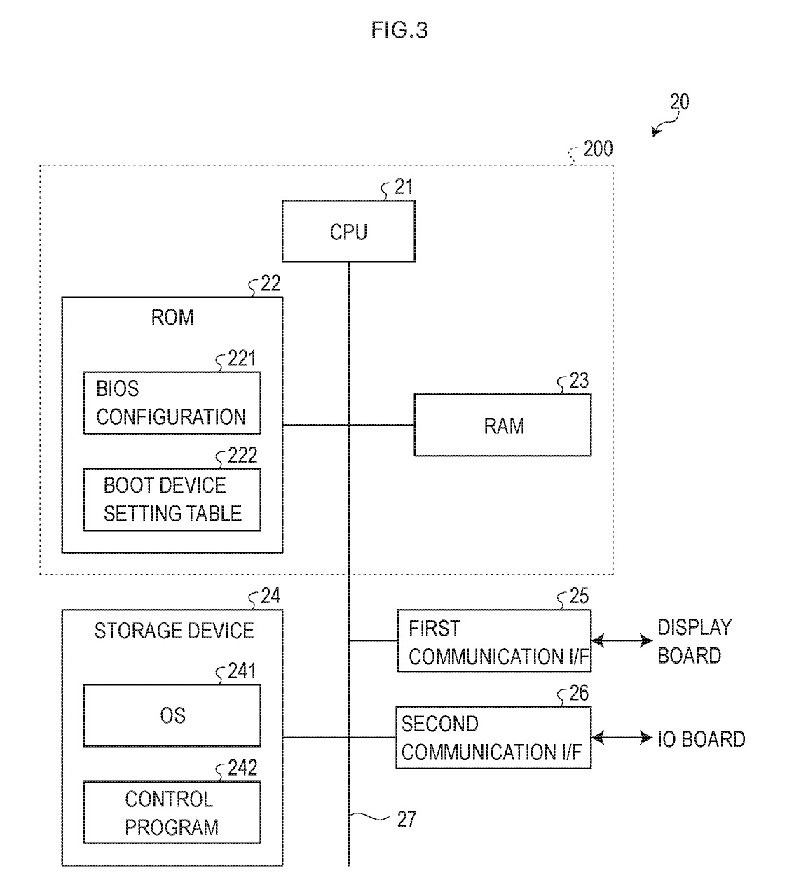

The card reader/writer 16 reads information necessary for a payment process for items registered in the registration process from a card medium, such as a loyalty card, an e-money prepaid card, or a credit card. The information necessary for the payment process includes, for example, a bank account used for credit card payment or a loaded amount on an e-money prepaid card. Also, the card reader/writer 16 reads information from and writes information to a card medium, such as a credit card, an e-money prepaid card, or a postpaid card. For example, the card reader/writer 16 reads information used for credit card payment or electronic payment and outputs the read information to a control unit 200 (see FIG. 3). Also, according to a command from the control unit 200, the card reader/writer 16 adds points corresponding to the purchased amount to a loyalty card.

When the customer selects cash payment, the change machine 17 receives bills and/or coins inserted by the customer for the payment of items. The change machine 17 dispenses change in bills and/or coins by subtracting the purchase amount of items from the total amount of inserted bills and/or coins. The change machine 17 includes a bill insertion slot 171 for inserting bills, a bill discharge slot 172 for discharging bills as change, a coin insertion slot 173 for inserting coins, and a coin discharge slot 174 for discharging coins as change.

The receipt printer 18 prints the result of the payment process on a receipt and outputs the receipt from a receipt discharge port 181.

The warning light 19 is implemented by, for example, a red LED and turns on or flashes when a fault occurs in the POS terminal 1 or when calling a store clerk.

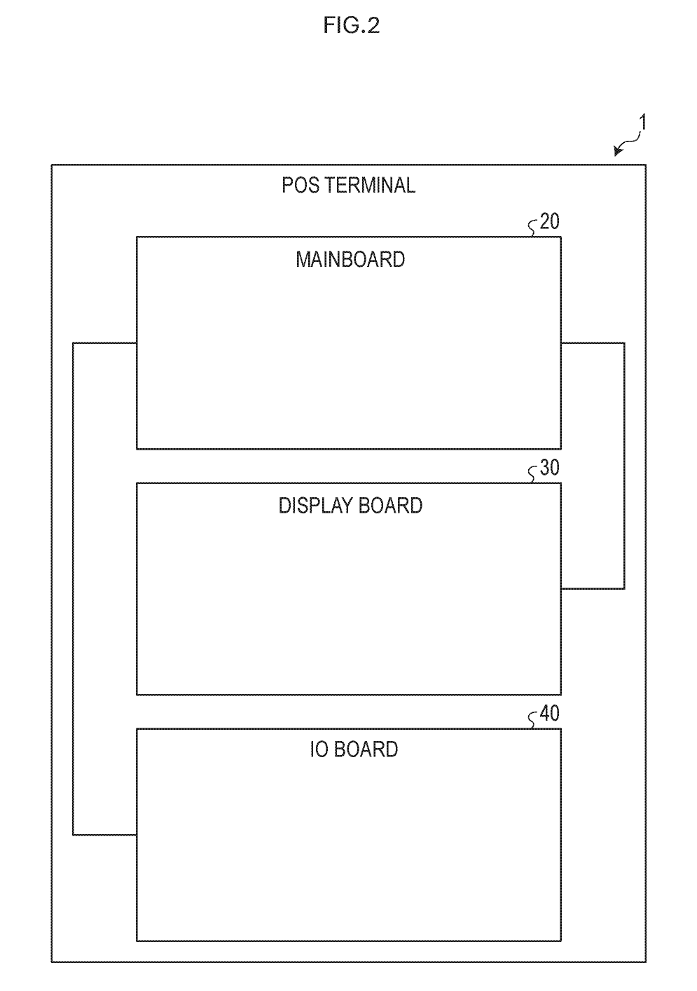

Next, a hardware configuration of the POS terminal 1 is described. FIG. 2 is a block diagram illustrating a hardware configuration of the POS terminal 1 according to the embodiment.

The POS terminal 1 includes a mainboard 20, a display board 30, and an input/output (I/O) board 40. The mainboard 20 is connected to the display board 30 and the I/O board 40 for communication via, for example, universal serial bus (USB) cables.

The mainboard 20 is an example of a first board. The mainboard 20 is a control board that controls the entire POS terminal 1. The mainboard 20 includes multiple components for controlling the POS terminal 1.

The display board 30 is an example of a second board or a third board. The display board 30 is a control board that controls the display device 13 of the POS terminal 1. The display board 30 includes the display device 13 and multiple components for controlling the display device 13.

The I/O board 40 is an example of the second board or the third board. The I/O board 40 is a control board that controls peripheral devices connected to the POS terminal 1. The I/O board 40 includes multiple components for controlling the peripheral devices.

Next, a hardware configuration of the mainboard 20 is described.

FIG. 3 is a block diagram illustrating a hardware configuration of the mainboard 20 according to the embodiment. As illustrated in FIG. 3, the mainboard 20 includes a central processing unit (CPU) 21, a read-only memory (ROM) 22, a random access memory (RAM) 23, a storage device 24, a first communication I/F 25, and a second communication I/F 26.

The CPU 21 is an example of a first processor configured to control operation of the POS terminal 1. The ROM 22 stores various programs. The ROM 22 is implemented by, for example, a rewritable ROM, such as an electrically erasable programmable ROM (EEPROM) or a flash ROM. The ROM 22 is an example of a memory and stores a basic input/output system (BIOS) 221 and a boot device setting table 222. The BIOS 221 includes programs and settings for various processes that are performed between power-on and OS startup of the POS terminal 1. Details of the boot device setting table 222 are described later.

The RAM 23 is a workspace into which programs and various types of data are loaded.

The storage device 24 is implemented by a non-volatile memory, such as a hard disk drive (HDD) or a solid state drive (SSD), that retains information even when the power is turned off. The storage device 24 stores an operating system (OS) 241 and a control program 242.

The OS 241 is, for example, Windows (registered trademark) or Linux (registered trademark) and is software for controlling the operation of the POS terminal 1. The OS 241 is an example of software to be executed during boot of the POS terminal 1. The OS 241 may be the same as or different from an OS 341 and an OS 441 described later.

The control program 242 is for controlling the POS terminal 1.

The CPU 21, the ROM 22, the RAM 23, and the storage device 24 are connected to each other via a bus 27. The CPU 21, the ROM 22, and the RAM 23 constitute a control unit 200 with a computer configuration. In the control unit 200, the CPU 21 operates according to the control program 242 stored in the ROM 22 or the storage device 24 and loaded into the RAM 23 to perform control processes of the POS terminal 1.

The first communication I/F 25 is an interface for connecting the mainboard 20 to the display board 30. The first communication I/F 25 is, for example, an interface that complies with a USB standard and transmits and receives information to and from the display board 30 via a connection line, such as a USB cable.

The second communication I/F 26 is an interface for connecting the mainboard 20 to the I/O board 40. The second communication I/F 26 is, for example, an interface that complies with a USB standard and transmits and receives information to and from the I/O board 40 via a connection line, such as a USB cable.

The boot device setting table 222 is a data table that defines storage devices (hereafter referred to as "boot devices") used during boot of the POS terminal 1.

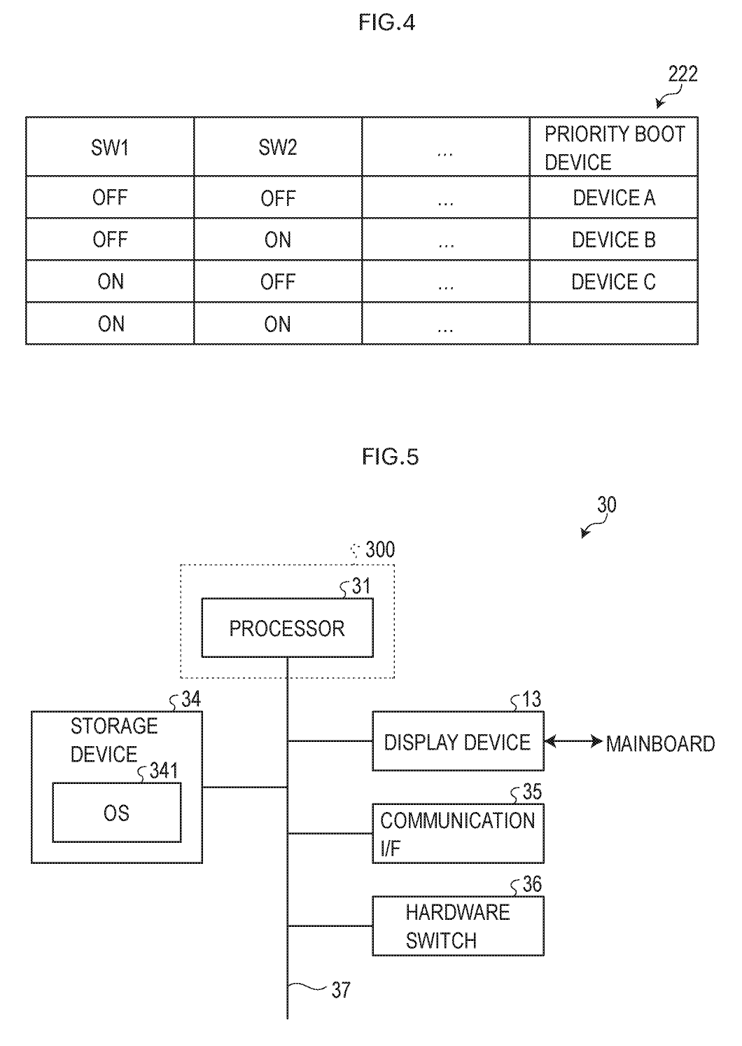

FIG. 4 shows an example of a data structure of the boot device setting table 222. The boot device setting table 222 stores switch configurations of a hardware switch 36 (see FIG. 5) in association with priority boot devices (or identifiers of boot devices). In the example of FIG. 4, it is assumed that the hardware switch 36 includes two switch elements SW1 and SW2 each of which can switch between ON and OFF states. That is, the hardware switch 36 can be set to four combinations of ON and OFF states (or switch configurations).

In the boot device setting table 222, “SW1” and “SW2” fields store the ON and OFF states of the switch elements SW1 and SW2, and the combinations of the ON and OFF states of the switch elements SW1 and SW2 represent the switch configurations of the hardware switch 36.

A "priority boot device" field stores the identifiers of boot devices used during boot of the POS terminal 1 in association with the switch configurations of the hardware switch 36. In the example of FIG. 4, when SW1 is OFF and SW2 is OFF, "device A" is used as the boot device. When SW1 is OFF and SW2 is ON, "device B" is used as the boot device. Also, when SW1 is ON and SW2 is OFF, "device C" is used as the boot device. Here, the devices A through C correspond, respectively, to the storage device 24 and storage devices 34 and 44 described later. Storage devices assigned to devices A to C can be set freely. The storage devices 24, 34, and 44 are examples of boot devices.

The switch configurations of the hardware switch 36 are not limited to the example shown in FIG. 4. The hardware switch 36 may include one or three or more switches. Also, the hardware switch 36 may be configured to be set to states other than ON and OFF.

Next, a hardware configuration of the display board 30 is described.

FIG. 5 is a block diagram illustrating a hardware configuration of the display board 30 according to the embodiment. As illustrated in FIG. 5, the display board 30 includes, in addition to the display device 13 illustrated in FIG. 1, a processor 31, a storage device 34, a communication I/F 35, and the hardware switch 36.

The processor 31 is an example of a third processor configured to control the display device 13 and other components of the display board 30. The processor 31 is implemented by a computer, such as a microcomputer.

The storage device 34 is implemented by a non-volatile memory, such as an HDD or an SSD, that retains information even when the power is turned off. The storage device 34 stores, for example, the OS 341. The OS 341 is an example of software to be executed during boot of the POS terminal 1.

The OS 341 is, for example, Windows (registered trademark) or Linux (registered trademark) and is software for controlling the operation of the POS terminal 1.

The processor 31 and the storage device 34 are connected to each other via a bus 37. The processor 31 constitutes a control unit 300 with a computer configuration. The control unit 300 may also include a ROM and/or a RAM.

The communication I/F 35 is an interface for connecting the display board 30 to the mainboard 20. The communication I/F 35 is, for example, an interface that complies with a USB standard and transmits and receives information to and from the mainboard 20 via a connection line, such as a USB cable.

The hardware switch 36 is, for example, a dual inline package (DIP) switch. The hardware switch 36 includes, for example, two switch elements SW1 and SW2 each of which can switch between ON and OFF states.

The hardware switch 36 may include any number of switch elements. However, the number of switch elements of the hardware switch 36 is preferably determined such that the boot devices included in the POS terminal 1 can be uniquely identified. For example, when the POS terminal 1 includes four boot devices and each switch element can switch between ON and OFF states (or two states), the number of switch elements of the hardware switch 36 is preferably two or more. In other words, the hardware switch 36 preferably includes a number of switch elements sufficient to generate combinations of ON and OFF states corresponding to the number of the boot devices.

The hardware switch 36 can be installed in any position on the display board 30. However, to improve the ease of operation for the operator of the hardware switch 36, the hardware switch 36 is preferably installed in a position, such as the back side of the display device 13, that is easily accessible to the operator. This enables the operator to easily select a boot device.

The hardware switch 36 may also be installed on a board, such as the I/O board 40, other than the display board 30. In this case, it is not necessary to install the hardware switch 36 on the display board 30.

Next, a hardware configuration of the I/O board 40 is described.

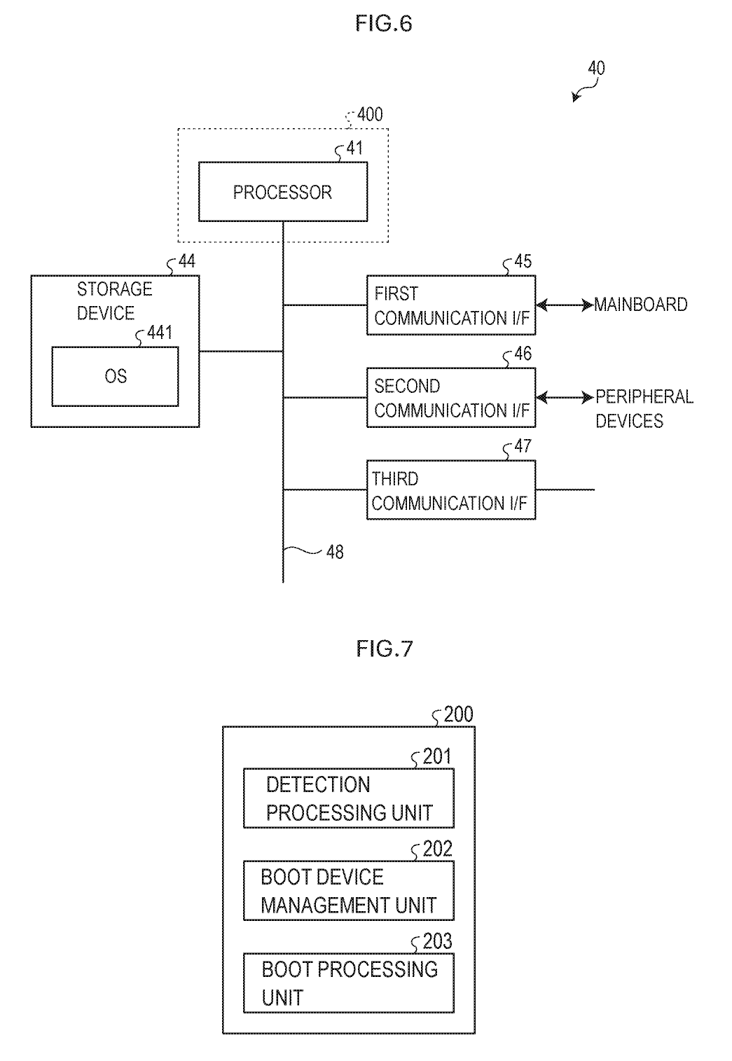

FIG. 6 is a block diagram illustrating a hardware configuration of the I/O board 40 according to the embodiment. As illustrated in FIG. 6, the I/O board 40 includes a processor 41, a storage device 44, a first communication I/F 45, a second communication I/F 46, and a third communication I/F 47.

The processor 41 is an example of a second processor configured to control the I/O board 40 and peripheral devices connected the POS terminal 1. The processor 41 is implemented by a computer, such as a microcomputer.

The storage device 44 is implemented by a non-volatile memory, such as an HDD or an SSD that retains information even when the power is turned off. The storage device 44 stores, for example, the OS 441.

The OS 441 is, for example, Windows (registered trademark) or Linux (registered trademark) and is software for controlling the operation of the POS terminal 1. The OS 441 is an example of software to be executed during boot of the POS terminal 1.

The processor 41 and the storage device 44 are connected to each other via a bus 48. The processor 41 constitutes a control unit 400 with a computer configuration. The control unit 400 may also include a ROM and/or a RAM.

The first communication I/F 45 is an interface for connecting the I/O board 40 to the mainboard 20. The first communication I/F 45 is, for example, an interface that complies with a USB standard and transmits and receives information to and from the mainboard 20 via a connection line, such as a USB cable.

The second communication I/F 46 is an interface for connecting the I/O board 40 to peripheral devices, such as the scanner 15, the change machine 17, and the receipt printer 18, included in the POS terminal 1. The second communication I/F 46 is, for example, an interface that complies with a USB standard and transmits and receives information to and from the peripheral devices via connection lines such as USB cables.

The third communication I/F 47 is an interface for connecting the I/O board 40 to external devices. For example, the third communication I/F 47 connects the I/O board 40 to a storage medium, such as a flash memory. This makes it possible to use the storage medium as a boot device. In other words, the storage medium connected to the I/O board 40 via the third communication I/F 47 can function as a boot device. The configuration of the I/O board 40 is not limited to the example illustrated in FIG. 6, and the I/O board 40 may include multiple third communication I/Fs 47.

The I/O board 40 may be an IO box that connects multiple devices, such as the mainboard 20 and peripheral devices, to each other and enables these devices to exchange information.

Next, a functional configuration implemented by the CPU 21 of the mainboard 20 and the BIOS 221 is described. FIG. 7 is a block diagram illustrating a functional configuration of the control unit 200 implemented by the BIOS 221 according to the embodiment.

As illustrated in FIG. 7, the control unit 200 includes a detection processing unit 201, a boot device management unit 202, and a boot processing unit 203 as functional components.

The detection processing unit 201 detects components of the mainboard 20 and other boards connected to the mainboard 20. For example, when the POS terminal 1 is powered on, the detection processing unit 201 detects components of the mainboard 20 and controls the components to place the components in an operable state. For example, the detection processing unit 201 detects that the mainboard 20 includes a boot device (or storage device 24), the first communication I/F 25, and the second communication I/F 26.

The detection processing unit 201 also detects components of other boards connected to the mainboard 20. Specifically, the detection processing unit 201 detects other boards (display board 30 and I/O board 40) connected to the first communication I/F 25 and the second communication I/F 26. Then, in collaboration with microcomputers (processors 31 and 41) of the other boards connected to the mainboard 20, the detection processing unit 201 detects components of the other boards and controls the components of the other boards to place the components in an operable state.

For example, in collaboration with the processor 31 of the display board 30, the detection processing unit 201 detects that the display board 30 includes a boot device (storage device 34), the display device 13, the communication I/F 35, and the hardware switch 36. Furthermore, in collaboration with the processor 31 of the display board 30, the detection processing unit 201 obtains information related to the switch configuration (or current configuration) of the hardware switch 36.

Also, in addition to the information related to the switch configuration of the hardware switch 36, the detection processing unit 201 obtains information related to the detected components of the boards (for example, identifiers of the boards and identifiers of the peripheral devices connected to the boards). Hereafter, the information related to the switch configuration of the hardware switch 36 and the information related to the detected components of the boards are collectively referred to as "status information".

Also, for example, in collaboration with the processor 41 of the I/O board 40, the detection processing unit 201 detects that the I/O board 40 includes a boot device (or storage device 44), the first communication I/F 45, the second communication I/F 46, and the third communication I/F 47.

The boot device management unit 202 manages boot devices used to boot the POS terminal 1. Specifically, the boot device management unit 202 determines a boot device used to boot the POS terminal 1 based on the information related to the switch configuration (or current configuration) of the hardware switch 36 obtained by the detection processing unit 201 and the boot device setting table 222.

Here, assume that the information related to the switch configuration of the hardware switch 36 obtained by the detection processing unit 201 indicates that SW1 is "OFF" and SW2 is "OFF". In this case, the boot device management unit 202 determines "device A", that is, the storage device 24, as the boot device based on the boot device setting table 222.

As another example, assume that the information related to the switch configuration of the hardware switch 36 obtained by the detection processing unit 201 indicates that SW1 is "OFF" and SW2 is "ON". In this case, the boot device management unit 202 determines "device B", that is, the storage device 34, as the boot device based on the boot device setting table 222.

The boot processing unit 203 starts an operating system. For example, the boot processing unit 203 performs a process for booting the POS terminal 1 based on the boot device determined by the boot device management unit 202. Specifically, the boot processing unit 203 boots the POS terminal 1 by starting the OS stored in the boot device.

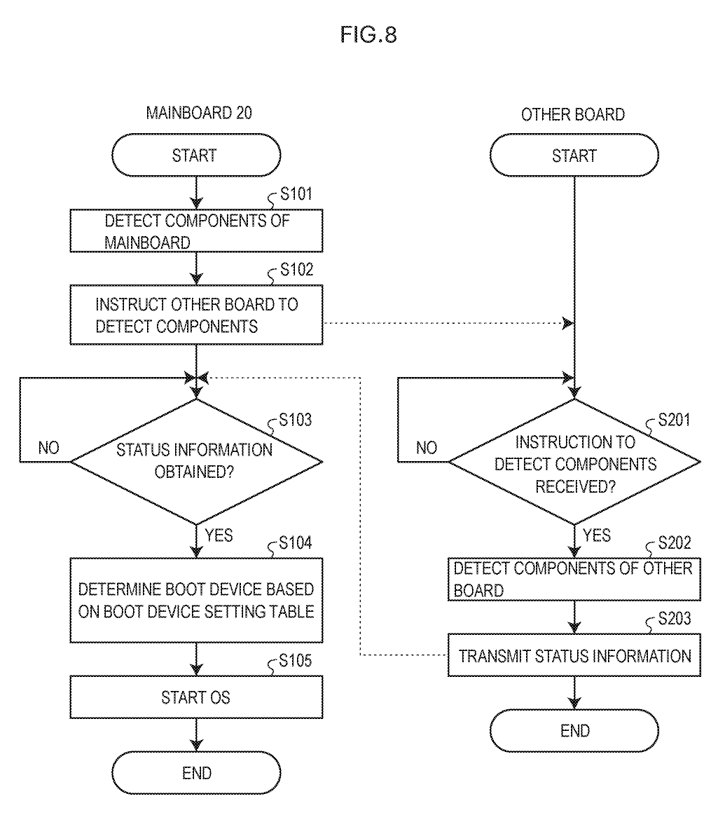

Next, a process performed by the POS terminal 1 is described with reference to FIG. 8. FIG. 8 is a flowchart illustrating a process performed by the POS terminal 1 according to the embodiment. Here, it is assumed that this process is performed immediately after the POS terminal 1 is powered on. In the descriptions below, each of boards, such as the display board 30 and the I/O board 40, other than the mainboard 20 is referred to as "the other board".

When the POS terminal 1 is powered on, the detection processing unit 201 detects components of the mainboard 20 and controls the components to place the components in an operable state (step S101). Next, the detection processing unit 201 instructs the other board to detect components on the other board (step S102).

The microcomputer (or control unit) of the other board waits until an instruction to detect components is received from the mainboard 20 (step S201: NO). Upon receiving the instruction to detect components (step S201: YES), the microcomputer of the other board detects components of the other board in collaboration with the detection processing unit 201 and controls the components of the other board to place the components in an operable state (Step S202). Next, the microcomputer (or control unit) of the other board transmits status information to the mainboard 20 (step S203).

Next, the control unit 200 of the mainboard 20 determines whether the status information has been obtained from the other board (step S103). When determining that the status information has not been obtained (step S103: NO), the control unit 200 waits until the status information is obtained.

When it is determined at step S103 that the status information has been obtained (step S103: YES), the boot device management unit 202 determines a boot device used to boot the POS terminal 1 based on the status information (including information related to the switch configuration of the hardware switch 36) and the boot device setting table 222 (step S104). Subsequently, the boot processing unit 203 boots the POS terminal 1 by starting the OS stored in the boot device determined at step S104 (step S105). Thus, the CPU 21 (or first processor) of the mainboard 20 is configured to detect components of the mainboard 20 to generate status information of the mainboard 20, instruct the processor 41 (or second processor) of the I/O board 40 to detect the components of the I/O board 40 and generate status information of the I/O board 40, instruct the processor 31 (or third processor) of the display board 30 to detect the components of the display board 30 and generate status information of the display board 30, obtain the status information from each of the I/O board 40 and the display board 30, and determine a boot device specified by the hardware switch 36 based on the boot device setting table 222, the current configuration of the hardware switch 36 obtained from the display board 30, and the status information of each of the mainboard 20, the I/O board 40, and the display board 30.

Through the process described above, the mainboard 20 of the POS terminal 1 can detect the current configuration of the hardware switch 36, which is provided on a board other than the mainboard 20, during boot of the POS terminal 1 and can boot the POS terminal 1 using the boot device corresponding to the current configuration of the hardware switch 36.

As described above, the POS terminal 1 (which is an example of an information processing apparatus) of the present embodiment includes a first board (mainboard 20) including a control unit that controls the booting of the POS terminal 1; one or more second boards (I/O board 40) that are connected to the first board and include storage devices each of which stores software to be executed during boot of the POS terminal; and a third board (display board 30) that is connected to the first board and includes a switch (hardware switch 36) configurable to specify one of the storage devices of the second board. The control unit boots the POS terminal 1 based on the software stored in one of the storage devices that is specified by the switch.

With this configuration, it is possible to select a boot device by setting the hardware switch 36 provided on the display board 30. This in turn makes it possible to easily select a boot device.

The above embodiment may be modified as appropriate by changing some of the components and/or functions of the above-described devices. Therefore, variations of the above embodiment are described below as other embodiments. Below, features different from the above embodiment are mainly described, and detailed descriptions of common features are omitted. Also, the variations described below may be implemented individually or may be implemented in any appropriate combination.

### First Variation

In the above embodiment, the display board 30 includes the hardware switch 36. However, the hardware switch 36 may be included in a board other than the display board 30. In this case, the board including the hardware switch 36 preferably includes a processor (or control unit) configured to provide information related to the switch configuration of the hardware switch 36 to the control unit 200. The board including the hardware switch 36 does not have to include any boot device.

For example, when the I/O board 40 includes the hardware switch 36, the detection processing unit 201 detects that the I/O board 40 includes the hardware switch 36 in collaboration with the processor 41 of the I/O board 40. Also, the detection processing unit 201 obtains information related to the switch configuration of the hardware switch 36 in collaboration with the processor 41 of the I/O board 40.

Also, the board including the hardware switch 36 may be connected to a first board (for example, the mainboard 20) via a second board (for example, the I/O board 40) that includes a storage device storing the software related to the boot of the POS terminal 1. For example, when the display board 30 includes the hardware switch 36, the display board 30 may be connected to the mainboard 20 via the I/O board 40.

This makes it possible to install the board including the hardware switch 36 in any position and thereby makes it possible to improve the operability of the hardware switch 36.

### Second Variation

In the above embodiment, the storage device 24 of the mainboard 20 stores the OS 241. However, the mainboard 20 does not have to include the OS 241. In other words, the mainboard 20 does not have to include the storage device (boot device) storing the software to be executed during boot of the POS terminal 1.

### Third Variation

A storage medium (hereafter referred to as "device D") connected to the I/O board 40 via the third communication I/F 47 may store the software to be executed during boot of the POS terminal 1.

In this case, the device D may be set as a priority boot device in the boot device setting table 222. For example, in the boot device setting table 222, the device D may be associated with a switch configuration in which SW1 is ON and SW2 is ON.

Programs to be executed by the information processing apparatuses according to the above embodiment and variations may be stored in a computer connected to a network, such as the Internet, and may be downloaded via the network. Also, programs to be executed by the information processing apparatuses according to the above embodiment and variations may be provided or distributed via a network, such as the Internet.

Programs to be executed by the devices according to the above embodiment may be prestored in a ROM or a storage device. Programs to be executed by the devices according to the above embodiment may be provided on a computer-readable non-transitory storage medium, such as a CD-ROM, a flexible disk (FD), a CD-R, or a digital versatile disc (DVD), in an installable or executable file format.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An information processing apparatus comprising:
a mainboard including a first processor configured to control operation of the information processing apparatus;
an input/output (I/O) board connected to the mainboard and including a second processor configured to control peripheral devices connected to the information processing apparatus; and
a display board connected to the mainboard and including a display device and a third processor configured to control the display device, wherein
at least two of the mainboard, the I/O board, and the display board include respective boot devices, each of the boot devices storing software to be executed during boot of the information processing apparatus;
one of the I/O board and the display board includes a switch configurable to specify one of the boot devices; and
the first processor of the mainboard is configured to:
determine the one of the boot devices specified by the switch, and
execute the software stored in the determined one of the boot devices to boot the information processing apparatus.

2. The information processing apparatus according to claim 1, wherein
the mainboard includes a memory storing a table including identifiers of the boot devices and configurations of the switch that are associated with the identifiers of the boot devices, and
the first processor of the mainboard is configured to determine the one of the boot devices specified by the switch based on the table and a current configuration of the switch obtained from the one of the I/O board and the display board.

3. The information processing apparatus according to claim 2, wherein
the first processor of the mainboard is configured to:
obtain status information of each of the mainboard, the I/O board, and the display board, the status information indicating components included in each of the mainboard, the I/O board, and the display board, and
determine the one of the boot devices specified by the switch based on the table, the current configuration of the switch, and the status information of each of the mainboard, the I/O board, and the display board.

4. The information processing apparatus according to claim 3, wherein
the first processor of the mainboard is configured to:
detect the components of the mainboard to generate the status information of the mainboard,
instruct the second processor of the I/O board to detect the components of the I/O board and generate the status information of the I/O board,
instruct the third processor of the display board to detect the components of the display board and generate the status information of the display board, and
obtain the status information from each of the I/O board and the display board.

5. The information processing apparatus according to claim 2, wherein
the switch is a dual inline package (DIP) switch including multiple switch elements, and
the configurations of the switch are represented by combinations of ON and OFF states of the switch elements.

6. The information processing apparatus according to claim 5, wherein the switch includes a number of switch elements sufficient to generate combinations of ON and OFF states corresponding to the number of the boot devices.

7. The information processing apparatus according to claim 1, wherein the software stored in each of the boot devices is an operating system.

8. The information processing apparatus according to claim 7, wherein the boot devices store different operating systems.

9. The information processing apparatus according to claim 1, wherein the switch is disposed on a back side of the display device of the display board.

10. The information processing apparatus according to claim 9, wherein the display board is connected to the mainboard via the I/O board.

11. The information processing apparatus according to claim 1, wherein each of the I/O board and the display board is connected to the mainboard via a USB cable.

12. The information processing apparatus according to claim 1, wherein the I/O board includes an interface for connecting a storage medium that functions as one of the boot devices.

13. The information processing apparatus according to claim 1, wherein
the information processing apparatus is a point-of-sale (POS) terminal including a scanner, a change machine, and a receipt printer as the peripheral devices, and
the scanner, the change machine, and the receipt printer are connected to the I/O board.

14. A method performed by an information processing apparatus including
a mainboard including a first processor configured to control operation of the information processing apparatus,
an input/output (I/O) board connected to the mainboard and including a second processor configured to control peripheral devices connected to the information processing apparatus, and
a display board connected to the mainboard and including a display device and a third processor configured to control the display device,
at least two of the mainboard, the I/O board, and the display board including respective boot devices, each of the boot devices storing software to be executed during boot of the information processing apparatus, one of the I/O board and the display board including a switch configurable to specify one of the boot devices,
the method comprising:
determining, by the first processor of the mainboard, the one of the boot devices specified by the switch; and
executing, by the first processor of the mainboard, the software stored in the determined one of the boot devices to boot the information processing apparatus.

15. The method according to claim 14, wherein
the mainboard includes a memory storing a table including identifiers of the boot devices and configurations of the switch that are associated with the identifiers of the boot devices, and
the one of the boot devices specified by the switch is determined based on the table and a current configuration of the switch obtained from the one of the I/O board and the display board.

16. The method according to claim 15, further comprising:
obtaining, by the first processor of the mainboard, status information of each of the mainboard, the I/O board, and the display board, the status information indicating components included in each of the mainboard, the I/O board, and the display board, wherein
the one of the boot devices specified by the switch is determined based on the table, the current configuration of the switch, and the status information of each of the mainboard, the I/O board, and the display board.

17. The method according to claim 16, further comprising:
detecting, by the first processor of the mainboard, the components of the mainboard to generate the status information of the mainboard;
instructing, by the first processor of the mainboard, the second processor of the I/O board to detect the components of the I/O board and generate the status information of the I/O board;
instructing, by the first processor of the mainboard, the third processor of the display board to detect the components of the display board and generate the status information of the display board; and
obtaining, by the first processor of the mainboard, the status information from each of the I/O board and the display board.

18. The method according to claim 15, wherein
the switch is a dual inline package (DIP) switch including multiple switch elements, and
the configurations of the switch are represented by combinations of ON and OFF states of the switch elements.

19. The method according to claim 14, wherein the software stored in each of the boot devices is an operating system.

20. A non-transitory computer readable storage medium storing a program for causing one or more processors of an information processing apparatus to perform a process,
the information processing apparatus including
a mainboard configured to control operation of the information processing apparatus,
an input/output (I/O) board connected to the mainboard and configured to control peripheral devices connected to the information processing apparatus, and
a display board connected to the mainboard and including a display device,
at least two of the mainboard, the I/O board, and the display board including respective boot devices, each of the boot devices storing software to be executed during boot of the information processing apparatus, one of the I/O board and the display board including a switch configurable to specify one of the boot devices,
the process comprising:
determining the one of the boot devices specified by the switch; and
executing the software stored in the determined one of the boot devices to boot the information processing apparatus.
